(19) United States
(12) Patent Application Publication
(10) Pub. No.: US 2022/0169952 A1
(43) Pub. Date: Jun. 2, 2022

(54) AUTOMATIC DISHWASHING COMPOSITION COMPRISING AMPHIPHILIC GRAFT POLYMER

(71) Applicant: The Procter & Gamble Company, Cincinnati, OH (US)

(72) Inventors: Lindsay Suzanne BEWICK, Tyne & Wear (GB); Patrick Firmin August DELPLANCKE, STEENHUIZE-WIJNHUIZE (BE); Katrien Andrea Lieven VAN ELSEN, LIEZELE-DORP 59/2 PUURS (BE)

(21) Appl. No.: 17/519,607

(22) Filed: Nov. 5, 2021

(30) Foreign Application Priority Data
Nov. 17, 2020 (EP) 20208148.5

(51) Int. Cl. C11D 3/37; C11D 3/33; C11D 3/20; C11D 3/386; C11D 11/00

(52) U.S. Cl. CPC C11D 3/3788; C11D 3/33; C11D 3/2082; C11D 11/0035; C11D 3/38618; C11D 11/0029; C11D 3/2086

(57) ABSTRACT

A phosphate-free automatic dishwashing cleaning composition having from about 20% to about 50% by weight of the composition of a complexing agent selected from the group consisting of methyl glycine diacetic acid, its salts and derivatives thereof citric acid, its salts and derivatives thereof, glutamic-N,N-diacetic acid, its salts and derivatives thereof, iminodisuccinic acid, its salts and derivatives thereof, carboxy methyl inulin, its salts and derivatives thereof, aspartic acid-N,N-diacetic acid, its salts and derivatives thereof, and mixtures thereof; and an amphiphilic graft polymer based on water-soluble polyalkylene oxides as a graft base and side chains formed by polymerization of a vinyl ester component, wherein said amphiphilic graft polymer is water-soluble or water-dispersible and has a weight average molar mass (Mw) of from about 3,000 to about 100,000; and optionally a dispersant polymer.

### FIELD OF THE INVENTION

The present invention is in the field of automatic dishwashing. In particular, it relates to a composition to provide improved cleaning, more in particular to provide grit prevention.

### BACKGROUND OF THE INVENTION

A frequent problem found in automatic dishwashing is the presence of grit on washed items. Grit is sometimes found on dishware/tableware after the automatic dishwashing process even if the items were free of it before they went into the dishwasher. It seems that grit is formed during the dishwashing process. The mechanism of grit formation is not well understood. It might be due to the high temperatures and combination of different soils, including oily soils, lifted from the soiled items during the dishwashing process. Somehow, different soils seem to recombine to give rise to grit which are small particles that deposit onto the surface of the washed items. Once the grit is formed and deposited it is very difficult to remove it.

Another problem encounter during automatic dishwashing is the staining of the interior of the dishwasher, including the racks and the filter.

It is an objective of the invention to provide an automatic dishwashing composition that provides good cleaning even when the dishwasher load is heavily loaded with greasy soils. It is another objective of the present invention to provide a cleaning composition that prevents the staining of the interior of the dishwasher, more in particular, the composition should prevent the staining of the filter when the dishwasher load contains a high level of greasy soils.

### SUMMARY OF THE INVENTION

According to the first aspect of the invention, there is provided a phosphate-free automatic dishwashing cleaning composition. By “phosphate-free” is herein understood that the composition comprises less than 1% or less than 0.1% by weight of the composition of phosphate. The composition comprises a high level of a complexing agent, an amphiphilic graft polymer and optionally a dispersant polymer. The amphiphilic graft polymer is based on water-soluble polyalkylene oxides as a graft base and side chains formed by polymerization of a vinyl ester component, the amphiphilic graft polymer is preferably water-soluble or water-dispersible and has a weight average molar mass (Mw) of from about 3,000 to about 100,000.

The composition of the invention prevents grit formation even when the dishwasher load contains a high amount of greasy soils. The composition also prevents the staining of the interior parts of the dishwasher, including the staining of the filter.

According to the second aspect of the invention, there is provided a method of automatic dishwashing using the composition of the invention and according to a further aspect of the invention, there is provided the use of the composition of the invention to provide grit prevention and to prevent staining of the plastic parts in the interior of a dishwasher.

The elements of the first aspect of the invention apply mutatis mutandis to the subsequent aspects of the invention.

### DETAILED DESCRIPTION OF THE INVENTION

The present invention provides an automatic dishwashing cleaning composition comprising a complexing agent, an amphiphilic graft polymer and optionally a dispersant polymer. The present invention also provides a method of washing dishware in a dishwasher using the composition of the invention and the use of the composition to provide grit prevention and to provide prevention of staining of the interior parts of the dishwasher, especially it prevents the staining of the plastic parts of the dishwasher, including racks, cutlery basket and filter. The method of the invention preferably takes place in a domestic dishwasher.

Automatic dishwashing machines may be domestic or commercial/institutional machine types. Generally, the differences are in terms of size, volume of throughput and duration of the dishwashing process. This can mean the machines are designed in very different ways. Industrial/institutional machines often have much shorter but more energy intensive (e.g. higher temperature) cycles compared to domestic machines, and/or use much more aggressive chemistry. Typically, they will not use enzymes, because these need a certain contact time with the treated soils to perform effectively, and the commercial cycle time is too short. In the case of commercial dishwashers, the machines can be based on a conveyor system in which dishware is moved through a single or multiple tanks of the dishwasher, whereas in domestic machines the dishware will generally always remain stationary in one tank inside the dishwasher, and all the washing steps will occur in that single tank. In domestic dishwashing, it is conventional to include bleaches and enzymes in the detergent.

“Dishware” herein means cookware, dishware and tableware, i.e all items related to cooking and serving food and drinks that are usually washed in a dishwasher.

As used herein, the articles including “a” and “an” are understood to mean one or more of what is claimed or described. Unless otherwise noted, all component or composition levels are in reference to the active portion of that component or composition, and are exclusive of impurities, for example, residual solvents or by-products, which may be present in commercially available sources of such components or compositions. Unless specifically stated or the context otherwise requires, embodiments described herein apply equally to all aspects of the invention. Percentages quoted are by weight, unless otherwise stated or the context otherwise requires. All measurements are performed at 25° C. unless otherwise specified.

### Cleaning Composition

### Amphiphilic Graft Polymer

The amphiphilic graft polymer of the composition of the invention is based on water-soluble polyalkylene oxides as a graft base and side chains formed by polymerization of a vinyl ester component. The amphiphilic graft polymer is water-soluble or water-dispersible and has a weight average molar mass (Mw) of from about 3,000 to about 100,000, from about 6,000 to about 45,000 or from about 8,000 to about 30,000. The weight average molar mass Mw is defined by the following expression

$${\overline{M}}_{w} = \frac{{Σ}_{i} {N}_{i} {M}_{i}^{2}}{{Σ}_{i} {N}_{i} {M}_{i}}$$

Where Ni is the number of polymer molecules with molecular weight Mi.

Preferably, the amphiphilic graft polymer is soluble in water or in water/alcohol mixtures (for example a 25% by weight solution of diethylene glycol monobutyl ether in water). The amphiphilic graft polymer herein has a low cloud point which, for the amphiphilic graft polymer soluble in water at up to 50° C., is less than or equal to about 95° C., or less than or equal to about 85° C., or less than or equal to about 75° C., and, in 25% by weight diethylene glycol monobutyl ether, less than or equal to about 90° C. or from about 45 to about 85° C.

In a preferred embodiment, the amphiphilic graft polymer has low degree of branching (degree of grafting). The amphiphilic graft polymer herein can have, on average, based on the reaction mixture obtained, not more than about 1 graft site, not more than about 0.6 graft site, not more than about 0.5 graft site or not more than about 0.4 graft site per about 50 alkylene oxide units. The amphiphilic graft polymer herein may comprise, on average, based on the reaction mixture obtained, at least about 0.05 or at least about 0.1 graft site per about 50 alkylene oxide units. The degree of branching can be determined, for example, by means of 13C NMR spectroscopy from the integrals of the signals of the graft sites and the —CH2-groups of the polyalkylene oxide.

Preferably, in accordance with the low degree of branching, the molar ratio of grafted to ungrafted alkylene oxide units in the amphiphilic graft polymers is from about 0.002 to about 0.05, from about 0.002 to about 0.035, from about 0.003 to about 0.025, or from about 0.004 to about 0.02.

The composition of the present invention may comprise from about 0.01% to about 10%, from about 0.05% to about 5%, from about 0.1% to about 3%, or from about 0.1% to about 2% by weight of the total composition of the amphiphilic graft polymer.

In some embodiments, the amphiphilic graft polymer features a narrow molar mass distribution and hence a polydispersity Mw/Mn of generally less than or equal to about 3, or less than or equal to about 2.5, or less than or equal to about 2.3. In some embodiments, its polydispersity Mw/Mn is in the range from about 1.5 to about 2.2. The polydispersity of the amphiphilic graft polymer can be determined, for example, by gel permeation chromatography using narrow-distribution polymethyl methacrylates as the standard. In the above expression for polydispersity and throughout the rest of this description, Mw is the weight average molar mass as previously defined, and Mn is the number average molar mass defined by the following expression

$${\overline{M}}_{n} = \frac{{Σ}_{i} {N}_{i} {M}_{i}}{{Σ}_{i} {N}_{i}}$$

where Ni is the number of polymer molecules with molecular weight Mi.

Other embodiments of the amphiphilic graft polymer may also have only a low content of ungrafted polyvinyl ester. In general, the amphiphilic graft polymer comprises less than or equal to about 10%, less than or equal to about 7.5%, or less than or equal to about 5% by weight of ungrafted polyvinyl ester.

Some embodiments of the amphiphilic graft polymer have:

(A) from about 20% to about 70% by weight of a water-soluble polyalkylene oxide as a graft base and
(B) side chains formed by free-radical polymerization of from about 30% to about 80% by weight of a vinyl ester component composed of:
(B1) from about 70% to 100% by weight of vinyl acetate and/or vinyl propionate and
(B2) from 0% to about 30% by weight of a further ethylenically unsaturated monomer, typically in the presence of (A).

Preferred embodiments of the amphiphilic graft polymer have:

(A) from about 30% to about 60% by weight of a water-soluble polyethylene oxide as a graft base and
(B) side chains formed by free-radical polymerization of from about 40% to about 70% by weight of a vinyl ester compound composed of
(B1) from about 70% to about 100% by weight of vinyl acetate and/or vinyl propionate and
(B2) from about 0% to about 30% by weight of a further ethylenically unsaturated monomer, typically in the presence of (A).

Other embodiments comprise from about 25% to about 60% by weight of the graft base (A) and from about 40% to about 75% by weight of the polyvinyl ester component (B).

Water-soluble polyalkylene oxides suitable for forming the graft base (A) are in principle all polymers based on C2-C4-alkylene oxides which comprise at least about 50%, or at least about 60%, or at least about 75% by weight of ethylene oxide in copolymerized form. The polyalkylene oxides (A) may be the corresponding polyalkylene glycols in free form, i.e. with OH end groups, but they may also be capped at one or both end groups. Suitable end groups are, for example, C1-C25-alkyl, phenyl, and C1-C14-alkylphenyl groups.

Non-limiting examples of particularly suitable polyalkylene oxides (A) include:

(A1) polyethylene glycols which may be capped at one or both end groups, especially by C1-C25-alkyl groups, but are preferably not etherified, and have number average molar mass Mn of from about 1500 to about 20,000 or from about 2500 to about 15,000;
(A2) copolymers of ethylene oxide and propylene oxide and/or butylene oxide with an ethylene oxide content of at least about 50% by weight, which may likewise be capped at one or both end groups, for example by C1-C25-alkyl groups, but are preferably not etherified, and have number average molar masses Mn of from about 1500 to about 20,000 or from about 2500 to about 15,000;
(A3) chain-extended products having mean molar masses of from about 2500 to about 20,000, which are obtainable by reacting polyethylene glycols (A1) having number average molar masses Mn of from about 200 to about 5000 or copolymers (A2) having number average molar masses Mn of from about 200 to about 5000 with C2-C12-dicarboxylic acids or -dicarboxylic esters or C6-C18-diisocyanates.

In some embodiments, the graft bases (A) are polyethylene glycols (A1). The side chains of the inventive graft polymers are formed by polymerization of a vinyl ester component (B) in the presence of the graft base (A).

The vinyl ester component (B) may comprise of (B1) vinyl acetate, or vinyl propionate, or mixtures thereof. In some embodiments some preference may be given to vinyl acetate as the vinyl ester component (B). However, the side chains of the graft polymer can also be formed by copolymerizing vinyl acetate and/or vinyl propionate (B1) and a further ethylenically unsaturated monomer (B2). The fraction of monomer (B2) in the vinyl ester component (B) may be up to about 30% by weight, which corresponds to a content in the graft polymer of (B2) of about 24% by weight.

Suitable comonomers (B2) are, for example, monoethylenically unsaturated carboxylic acids and dicarboxylic acids and their derivatives, such as esters, amides and anhydrides, and styrene. It is also possible to use mixtures of different comonomers. Specific, non-limiting examples include (meth)acrylic acid, C1-C12-alkyl and hydroxy-C2-C12-alkyl esters of (meth)acrylic acid, (meth)acrylamide, N-C1-C12-alkyl(meth)acrylamide, N,N di(C1-C6-alkyl)(meth)acrylamide, maleic acid, maleic anhydride and mono(C1-C12-alkyl)esters of maleic acid. Some monomers (B2) are the C1-C8-alkyl esters of (meth)acrylic acid and hydroxyethyl acrylate. In some embodiments, particular preference may be given to C1-C4-alkyl esters of (meth)acrylic acid. Some embodiment may use methyl acrylate, ethyl acrylate, or n-butyl acrylate. When the amphiphilic graft polymer comprises the monomers (B2) as a constituent of the vinyl ester component (B), the content of graft polymers in (B2) may be from about 0.5% to about 20% by weight, or from about 1% to about 15% by weight, or from about 2% to about 10% by weight.

One method of preparing the amphiphilic graft polymer comprises the steps of: polymerizing a vinyl ester component (B) composed of vinyl acetate and/or vinyl propionate (B1) and, if desired, a further ethylenically unsaturated monomer (B2), in the presence of a water-soluble polyalkylene oxide (A), a free radical-forming initiator (C) and, if desired, up to about 40% by weight, based on the sum of components (A), (B) and (C), of an organic solvent (D), at a mean polymerization temperature at which the initiator (C) has a decomposition half-life of from about 40 to about 500 min, in such a way that the fraction of unconverted graft monomer (B) and initiator (C) in the reaction mixture is constantly kept in a quantitative deficiency relative to the polyalkylene oxide (A).

Suitable amphiphilic graft polymers herein are commercially available under the trade name Sokalan® HP22 from BASF.

Without intending to be limited by theory, it is believed that the amphiphilic graft polymer helps to suspend grease. The composition of the invention may comprise from about 0.1% to about 10%, from 0.2% to about 5%, or from 0.5% to 3% by weight of the composition of the amphiphilic graft polymer.

### Complexing Agent

Complexing agents are materials capable of sequestering hardness ions, particularly calcium and/or magnesium. The composition of the invention comprises a high level of complexing agent.

The composition of the invention comprises from 20% to 50%, from 20% to 40%, or from 20% to 35% by weight of the composition of a complexing agent selected from the group consisting of methylglycine-N,N-diacetic acid (MGDA), glutamic acid-N,N-diacetic acid (GLDA), iminodisuccinic acid (IDS), carboxy methyl inulin, citric acid, aspartic acid-N,N-diacetic acid (ASDA) its salts and mixtures thereof. Especially preferred complexing agents for use herein are selected from the group consisting of salts of MGDA, in particular the trisodium salt of MGDA, salts of citric acid, in particular the trisodium salt of citric acid, salts of GLDA, in particular the tetrasodium salt of GLDA and mixtures thereof. Mixtures of trisodium citrate and the trisodium salt of MGDA are also preferred for use herein. Preferred compositions comprise from 20% to 50% or from 25 to 40% by weight of the composition of the trisodium salt of MGDA. Preferred compositions comprise from 20% to 50% or from 25 to 40% by weight of the composition of the trisodium salt of citric acid. Preferred compositions comprise from 20% to 50% or from 25 to 40% by weight of the composition of a mixture of the trisodium salt of citric acid and the trisodium salt of MGDA. In one particular example, from 20% to 50% or from 25 to 40% by weight of the composition is the trisodium salt of MGDA.

### Dispersant Polymer

Preferably the composition comprises a dispersant polymer. Preferred dispersant polymers are selected from the group consisting of polyacrylates, sulfonated polymers and mixtures thereof. Especially preferred sulfonated polymer for use in the composition of the invention comprises 2-acrylamido-2-methylpropane sulfonic acid monomer. The composition may comprise from 0.1 to 15% or from 0.5 to 10% by weight of the composition of a dispersant polymer.

Suitable sulfonated polymers described herein may have a weight average molecular weight of less than or equal to about 100,000 Da, or less than or equal to about 75,000 Da, or less than or equal to about 50,000 Da, or from about 3,000 Da to about 50,000, or from about 5,000 Da to about 45,000 Da.

Preferred sulfonated monomers include one or more of the following: 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propen-1-sulfonic acid, styrenesulfonic acid, vinylsulfonic acid, 3-sulfopropyl, 3-sulfo-propylmethacrylate, sulfomethacrylamide, sulfomethylmethacrylamide and mixtures of said acids or their water-soluble salts.

The polymer may comprise the following levels of monomers: from about 40 to about 90% or from about 60 to about 90% by weight of the polymer of one or more carboxylic acid monomer; from about 5 to about 50% or from about 10 to about 40% by weight of the polymer of one or more sulfonic acid monomer; and optionally from about 1% to about 30% or from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

The carboxylic acid is preferably (meth)acrylic acid. The sulfonic acid monomer is preferably 2-acrylamido-2-propanesulfonic acid (AMPS).

Preferred commercially available polymers include: Alcosperse 240 and Aquatreat AR 540 supplied by Nouryon; Acumer 3100, Acumer 2000, Acusol 587G and Acusol 588G supplied by Dow. Particularly preferred polymers are Acusol 587G and Acusol 588G supplied by Dow.

Suitable polyacrylates include anionic carboxylic polymer of low molecular weight. They can be homopolymers or copolymers with a weight average molecular weight of less than or equal to about 200,000 g/mol, or less than or equal to about 75,000 g/mol, or less than or equal to about 50,000 g/mol, or from about 3,000 to about 50,000 g/mol or from about 5,000 to about 45,000 g/mol. The dispersant polymer may be a low molecular weight homopolymer of polyacrylate, with an average molecular weight of from 1,000 to 20,000, from 2,000 to 10,000, or from 3,000 to 5,000.

The polymer may be a copolymer of acrylic with methacrylic acid, acrylic and/or methacrylic with maleic acid, and acrylic and/or methacrylic with fumaric acid, with a molecular weight of less than 70,000. Their molecular weight ranges from 2,000 to 80,000, from 20,000 to 50,000 or from 30,000 to 40,000 g/mol. and a ratio of (meth)acrylate to maleate or fumarate segments of from 30:1 to 1:2.

The polymer may be a copolymer of acrylamide and acrylate having a molecular weight of from 3,000 to 100,000, alternatively from 4,000 to 20,000, and an acrylamide content of less than 50%, alternatively less than 20%, by weight of the dispersant polymer can also be used. Alternatively, such polymer may have a molecular weight of from 4,000 to 20,000 and an acrylamide content of from 0% to 15%, by weight of the polymer.

Polymers suitable herein also include itaconic acid homopolymers and copolymers. Alternatively, the polymer can be selected from the group consisting of alkoxylated polyalkyleneimines, alkoxylated polycarboxylates, polyethylene glycols, styrene co-polymers, cellulose sulfate esters, carboxylated polysaccharides and mixtures thereof.

### Enzymes

The cleaning composition preferably comprises enzymes, e.g. amylases and proteases. In describing enzyme variants herein, the following nomenclature is used for ease of reference: Original amino acid(s):position(s):substituted amino acid(s). Standard enzyme IUPAC 1-letter codes for amino acids are used.

### Proteases

The composition of the invention preferably comprises a protease. A mixture of two or more proteases can also contribute to an enhanced cleaning across a broader temperature, cycle duration, and/or substrate range, and provide superior shine benefits, especially when used in conjunction with a dispersant polymer.

Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include: (a) subtilisins (EC 3.4.21.62), especially those derived from Bacillus, such as Bacillus sp., B. lentus, B. alkalophilus, B. subtilis, B. amyloliquefaciens, B. pumilus , B. gibsonii, and B. akibaii described in WO2004067737, WO2015091989, W02015091990, WO2015024739, WO2015143360, U.S. Pat. Nos. 6,312,936, 5,679,630, 4,760,025, DE102006022216A1, DE 102006022224A1, WO2015089447, WO2015089441, WO2016066756, WO2016066757, WO2016069557, WO2016069563, WO2016069569.

(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.

(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. described in WO2014194032, WO2014194054 and WO2014194117; from Kribella alluminosa described in WO2015193488; and from Streptomyces and Lysobacter described in WO2016075078.

(d) protease having at least 90% identity to the subtilase from Bacillus sp. TY 145, NCIMB 40339, described in W092/17577 (Novozymes A/S), including the variants of this Bacillus sp TY145 subtilase described in WO2015024739, and WO2016066757.

(e) protease having at least 90% or at least 92% identity with the amino acid sequence of SEQ ID NO:85 from WO2016/205755 comprising at least one amino acid substitution (using the SEQ ID NO:85 numbering) selected from the group consisting of 1, 4, 9, 21, 24, 27, 36, 37, 39, 42, 43, 44, 47, 54, 55, 56, 74, 80, 85, 87, 99, 102, 114, 117, 119, 121, 126, 127, 128, 131, 143, 144, 158, 159, 160, 169, 182, 188, 190, 197, 198, 212, 224, 231, 232, 237, 242, 245, 246, 254, 255, 256, and 257, including the variants found in WO2016/205755 and WO2018/118950.

(f) protease having at least 90%, at least 92%, or at least 98% identity with the amino acid sequence of SEQ ID NO:1 from U.S. Pat. No. 10,655,090 B2. A preferred protease has 100% identity with SEQ ID NO:1 from U.S. Pat. No. 10,655,090 B2. Another preferred protease has 1 to 4 modifications with respect to SEQ ID NO:1 from U.S. Pat. No. 10,655,090 B2.

Especially preferred proteases for the detergent of the invention are:

(a) polypeptides demonstrating at least 90%, at least 95%, at least 98%, at least 99% or 100% identity with the wild-type enzyme from Bacillus lentus, comprising mutations in one or more, two or more or three or more of the following positions, using the BPN' numbering system and amino acid abbreviations as illustrated in WO00/37627, which is incorporated herein by reference: V68A, N76D, N87S, S99D, S99AD, S99A, S101G, S101M, S103A, V104N/I, G118V, G118R, S128L, P129Q, S130A, Y167A, R170S, A194P, V205I, Q206L/D/E, Y209W and/or M222S. and/or
(b) protease having at least 95%, at least 98%, at least 99% or 100% identity with the amino acid sequence of SEQ ID NO:85 from WO2016/205755 comprising at least one amino acid substitution (using the SEQ ID NO:85 numbering) selected from the group comprising:

### P54E/G/I/L/Q/S/T/V; S99A/E/H/I/K/M/N/Q/R/T/V; S126A/D/E/F/G/H/I/L/M/N/Q/R/T/V/Y; D127A/E/F/G/H/I/L/M/N/P/Q/S/T/V/W/Y; F128A/C/D/E/G/H/I/K/L/M/N/P/Q/R/S/T/W, A37T, S39E, A47V, T56Y, I80V, N85S, E87D, T114Q, and N242D;

The additional protease may be either selected from the group of proteases comprising the below mutations (BPN' numbering system) versus either the PB92 wild-type (SEQ ID NO:2 in WO 08/010925) or the subtilisin 309 wild-type (sequence as per PB92 backbone, except comprising a natural variation of N87S).

### (i) G118V+S128L+P129Q+S130A

### (ii) S101M+G118V+S128L+P129Q+S130A

(iii) N76D+N87R+G118R+S128L+P129Q+S130A+S188D+N248R

### (iv) N76D+N87R+G118R+S128L+P129Q+S130A+S188D+V244R

### (v) N76D+N87R+G118R+S128L+P129Q+S130A

### (vi) V68A+N87S+S101G+V104N

(vii) S99AD
or selected from the group of proteases comprising one or more, two or more, three or more, or four or more of the below mutations versus SEQ ID NO:1 from WO2018/118950:

### P54T, S99M, S126A/G, D127E, F128C/D/E/G, A37T, S39E, A47V, T56Y, I80V, N85S, E87D, T114Q, and N242D.

Most preferred for use herein are proteases wherein the protease is a variant having at least 60% identity with the amino acid sequence of SEQ ID NO:1 of WO2019/125894 A1 and comprising at least one amino acid substitution (using the SEQ ID NO: 1 numbering) selected from the group consisting of: X54T; X126A, D, G, V, E, K, I; X127E, S, T, A, P, G, C; and X128E, C, T, D, P, G, L, Y, N and X211L. Preferably, a variant having at least 90% identity with the amino acid sequence of SEQ ID NO:1 and said variant comprising at least one amino acid substitution (using the SEQ ID NO:1 numbering) selected from the group consisting of P54T, S126A, D127E, F128G and M211L

Other preferred protease for use herein include a protease wherein the protease is a variant having at least 90% identity with the amino acid sequence of SEQ ID NO:1 of WO2019/245839 A1 and the variant comprises one or more amino acid substitutions at one or more positions corresponding to SEQ ID NO: 1 positions selected from:

1C/D/E/M/N, 21L, 37A, 54A, 73V, 76D/H/N/T, 83G, 84D/E/F, 85I/M, 86I/S/T/V, 87T, 88M/V, 89F/W, 91I, 95A/N/S, 96M/Q, 97E, 98M, 99A/F/H/I/K/L/Q/T/W/Y, 102L, 104E, 105L, 106I/V, 108A, 109I, 112C, 114M/N, 115A/E/H/Q, 116A/E/G/H/Q, 118A/D/N, 122C, 124E/Q, 126I/Q/V, 128H/I/L/M/N/Q/S/T/V/Y, 129D/H, 130N, 131D/E/N/P/Q, 135A/D/H/K/L/M/N/Q/T/V/W/Y, 138D/E, 139E/L, 141A/E/F/H/Y, 142A/D/E, 143E/H/K/M/S/V, 156E, and 157C/D/E wherein the amino acid positions of the variant are numbered by correspondence with the amino acid sequence of SEQ ID NO: 1.

Suitable commercially available additional protease enzymes include those sold under the trade names Alcalase®, Savinase®, Primase®, Durazym®, Polarzyme®, Kannase®, Liquanase®, Liquanase Ultra®, Savinase Ultra®, Savinase Evity®, Ovozyme®, Neutrase®, Everlase®, Coronase®, Blaze®, Blaze Ultra®, Blaze Evity® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase®, Ultimase®, Extremase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D); and KAP (Bacillus alkalophilus subtilisin with mutations A230V+S256G+S259N) from Kao.

Especially preferred for use herein are commercial proteases selected from the group consisting of Properase®, Blaze®, Blaze Evity®, Savinase Evity®, Extremase®, Ultimase®, Everlase®, Savinase®, Excellase®, Blaze Ultra®, BLAP and BLAP variants. Preferred levels of protease in the composition of the invention include from about 0.05 to about 20, from about 0.5 to about 15 or from about 2 to about 12 mg of active protease/g of composition.

### Amylases

The composition of the invention may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCBI 12289, NCBI 12512, NCBI 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) variants described in WO 96/23873, WO00/60060, WO06/002643 and WO2017/192657, especially the variants with one or more substitutions in the following positions versus SEQ ID NO. 12 of WO06/002643:

26, 30, 33, 82, 37, 106, 118, 128, 133, 149, 150, 160, 178, 182, 186, 193, 202, 214, 231, 246, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D 183* and G184*.

(b) variants exhibiting at least 90% identity with SEQ ID No. 4 in W006/002643, the wild-type enzyme from Bacillus SP722, especially variants with deletions in the 183 and 184 positions and variants described in WO 00/60060, WO2011/100410 and W02013/003659 which are incorporated herein by reference.

(c) variants exhibiting at least 95% identity with the wild-type enzyme from Bacillus sp. 707 (SEQ ID NO:7 in U.S. Pat. No. 6,093, 562), especially those comprising one or more of mutations in the following positions M202, M208, 5255, R172, and/or M261. Preferably said amylase comprises one or more of M202L, M202V, M202S, M202T, M202I, M202Q, M202W, S255N and/or R172Q. Particularly preferred are those comprising the M202L or M202T mutations.

(d) variants described in WO 09/149130, e.g. those exhibiting at least 90% identity with SEQ ID NO: 1 or SEQ ID NO:2 in WO 09/149130, the wild-type enzyme from Geobacillus Stearophermophilus or a truncated version thereof.

(e) variants exhibiting at least 89% identity with SEQ ID NO:1 in WO2016091688, especially those comprising deletions at positions H183+G184 and additionally one or more mutations at positions 405, 421, 422 and/or 428.

(f) variants exhibiting at least 60% amino acid sequence identity with the “PcuAmyl a-amylase”from Paenibacillus curdlanolyticus YK9 (SEQ ID NO:3 in WO2014099523).

(g) variants exhibiting at least 60% amino acid sequence identity with the “CspAmy2 amylase” from Cytophaga sp. (SEQ ID NO:1 in WO2014164777).

(h) variants exhibiting at least 85% identity with AmyE from Bacillus subtilis (SEQ ID NO:1 in WO2009149271).

(i) variants exhibiting at least 90% identity with the wild-type amylase from Bacillus sp. KSM-K38 with accession number AB051102.

(j) variants exhibiting at least 80% identity with the mature amino acid sequence of AAI10 from Bacillus sp (SEQ ID NO:7 in WO2016180748), preferably comprising a mutation in one or more of the following positions modification in one or more positions 1, 54, 56, 72, 109, 113, 116, 134, 140, 159, 167, 169, 172, 173, 174, 181, 182, 183, 184, 189, 194, 195, 206, 255, 260, 262, 265, 284, 289, 304, 305, 347, 391, 395, 439, 469, 444, 473, 476, or 477

(k) variants exhibiting at least 80% identity with the mature amino acid sequence of the fusion peptide (SEQ ID NO:14 in US 2019/0169546), preferably comprising one or more of the mutations H1*, N54S+V56T, A60V, G109A, R116Q/H+W167F, L173V, A174S, Q172N, G182*, D183*,N195F, V206L/Y, V208L, K391A, K393A, I405L, A421H, A422P, A428T, G476K and/or G478K. Preferred amylases contain both the deletions G182* and G183* and optionally one or more of the following sets of mutations:

### 1. H1*+G109A+N195F+V206Y+K391A;

### 2. H1*+N54S+V56T+G109A+A1745+N195F+V206L+K391A+G476K)

### 3. H1*+N54S+V56T+A60V+G109A+R116Q+W167F+Q172N+L173V+A1745+N195F+V206L+I405L+A421H+A422P+A428T

### 4. H1*+N545+V56T+G109A+R116Q+A1745+N195F+V206L+I405L+A421H+A422P+A428T;

### 5. H1*+N545+V56T+G109A+R116H+A1745+N195F+V208L+K393A+G478K;

(l) variants exhibiting at least 80% identity with the mature amino acid sequence of Alicyclobacillus sp. amylase (SEQ ID NO:8 in WO2016180748).

The amylase can be an engineered enzyme, wherein one or more of the amino acids prone to bleach oxidation have been substituted by an amino acid less prone to oxidation. In particular it is preferred that methionine residues are substituted with any other amino acid. In particular it is preferred that the methionine most prone to oxidation is substituted. Preferably the methionine in a position equivalent to 202 in SEQ ID NO:2 is substituted. Preferably, the methionine at this position is substituted with threonine or leucine, preferably leucine.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL®, ATLANTIC®, INTENSA® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE®, PREFERENZ S® series (including PREFERENZ S1000® and PREFERENZ S2000® and PURASTAR OXAM® (DuPont., Palo Alto, Calif.) and KAM® (Kao, 14-10 Nihonbashi Kayabacho, 1-chome, Chuo-ku Tokyo 103-8210, Japan). In one aspect, suitable amylases include ATLANTIC®, STAINZYME®, POWERASE®, INTENSA® and STAINZYME PLUS®, ACHIEVE ALPHA® and mixtures thereof.

The composition of the invention may comprise at least 0.01 mg, from about 0.05 to about 10, from about 0.1 to about 6, or from about 0.2 to about 5 mg of active amylase/g of composition.

The protease and/or amylase of the composition of the invention may be in the form of granulates. The granulates may comprise more than 29% of sodium sulfate by weight of the granulate and/or the sodium sulfate and the active enzyme (protease and/or amylase) are in a weight ratio of between 3:1 and 100:1, between 4:1 and 30:1 or between 5:1 and 20:1.

### Inorganic Builder

The cleaning composition preferably comprises an inorganic builder. Suitable inorganic builders are selected from the group consisting of carbonate, silicate and mixtures thereof. Especially preferred for use herein are sodium carbonate and silicate. The cleaning composition may comprise from 5 to 50%, from 10 to 40% or from 15 to 30% of sodium carbonate by weight of the composition.

### Nonionic Surfactant

Surfactants suitable for use herein include non-ionic surfactants. The compositions may be free of any other surfactants, or the compositions may be free of anionic surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

The cleaning composition may comprise a non-ionic surfactant or a non-ionic surfactant system, wherein the non-ionic surfactant or a non-ionic surfactant system has a cloud point, as measured at a concentration of 1% in distilled water, between 20 and 70° C. or between 35 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

The cloud point is the temperature at which a non-ionic surfactant solution phase separates into a water rich and surfactant rich phase and becomes cloudy. The cloud point temperature can be determined visually by identifying at which temperature cloudiness occurs.

The cloud point temperature of a non-ionic surfactant can be determined as follows: a solution containing 1% of the corresponding non-ionic surfactant by weight of the solution is prepared in distilled water. The solution is stirred gently before analysis to ensure that the process occurs in chemical equilibrium. The cloud point temperature is taken in a thermostatic bath by immersing the surfactant solution in a 75 mm sealed glass test tube. To ensure the absence of leakage, the test tube is weighed before and after the cloud point temperature measurement. The temperature is gradually increased at a rate of less than 1° C. per minute, until the temperature reaches a few degrees below the pre-estimated cloud point. The cloud point temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with at least 3 moles, at least 5 moles, or at least 7 moles of ethylene oxide per mole of alcohol or alkylphenol; ii) alcohol alkoxylated surfactants having from 6 to 20 carbon atoms and at least one ethoxy and propoxy group. Preferred for use herein are mixtures of surfactants i) and ii).

Other suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5 or about 1; and y is an integer having a value of at least 15, or at least 20.

The surfactant of formula I comprises at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the composition of the invention. Preferred are C10-C18 alkyl dimethylamine oxide, and C10-18 acylamido alkyl dimethylamine oxide.

The composition of the invention comprises from about 0.1 to about 30% by weight of the composition, or from about 0.5 to about 20% by weight of the composition of non-ionic surfactants.

### Crystal Growth Inhibitor

Crystal growth inhibitors are materials that can bind to calcium carbonate crystals and prevent further growth of species such as aragonite and calcite.

Especially preferred crystal growth inhibitor for use herein is a sodium salt of HEDP (1-hydroxyethylidene 1,1-diphosphonic acid). The cleaning composition comprises from 0.01 to 10%, from 0.1 to 8% or from 0.5 to 6% of a crystal growth inhibitor by weight of the composition, e.g. a sodium salt of HEDP.

### Metal Care Agents

Metal care agents may prevent or reduce the tarnishing, corrosion or oxidation of metals, including aluminium, stainless steel and non-ferrous metals, such as silver and copper. The cleaning composition comprises from 0.1 to 5%, from 0.2 to 4% or from 0.3 to 3% by weight of the composition of a metal care agent, e.g. benzotriazole (BTA).

### Glass Care Agents

Glass care agents protect the appearance of glass items during the dishwashing process. The cleaning composition may comprise from 0.1 to 5%, from 0.2 to 4% or from 0.3 to 3% by weight of the composition of a glass care agent, e.g. a zinc salt.

### Bleach

In some embodiments the composition may comprises from about 8 to about 30%, from about 9 to about 25%, or from about 9 to about 20% of bleach by weight of the composition.

Inorganic and organic bleaches are suitable for use herein. Inorganic bleaches include perhydrate salts such as perborate, percarbonate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially dodecanediperoxoic acid, tetradecanediperoxoic acid, and hexadecanediperoxoic acid. Mono- and diperazelaic acid, mono-and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for some embodiments include compounds which, under perhydrolysis conditions, give aliphatic peroxoycarboxylic acids having from 1 to 12 carbon atoms or from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the composition comprises from 0.01 to 5 or from 0.2 to 2% by weight of the composition of bleach activator, e.g. TAED.

### Bleach Catalyst

The cleaning composition may comprise a bleach catalyst, e.g. a metal containing bleach catalyst. The metal containing bleach catalyst can be a transition metal containing bleach catalyst, e.g. a manganese or cobalt-containing bleach catalyst.

Bleach catalysts preferred for use herein include manganese triazacyclononane and related complexes; Co, Cu, Mn and Fe bispyridylamine and related complexes; and pentamine acetate cobalt (III) and related complexes.

The cleaning composition may comprise from 0.001 to 0.5, from 0.002 to 0.05% of bleach catalyst by weight of the composition. The bleach catalyst can be a manganese bleach catalyst.
The cleaning composition of the invention may comprise:
i) from 0.5 to 10% by weight of the composition of the amphiphilic graft polymer;
ii) from 0.5 to 20% by weight of the composition of non-ionic surfactant;
iii) from 10 to 50% by weight of the composition of a complexing agent, wherein the complexing agent comprises a salt of MGDA;
iv) enzymes, wherein the enzymes comprise an amylase and a protease;
v) from 0.5 to 10% by weight of the composition of a sulfonated polymer;
vi) optionally from 5 to 20% by weight of the composition of bleach and/or a bleach catalyst;

Preferably the automatic dishwashing cleaning composition is in unit-dose form, more preferably in the form of a water-soluble pouch. By “unit-dose form” is herein meant that the composition is provided in a form sufficient to provide enough detergent for one wash. Suitable unit dose forms include tablets, sachets, capsules, pouches, etc. Preferred for use herein are compositions in unit-dose form wrapped in water-soluble material, for example polyvinyl alcohol. Especially preferred are compositions in unit dose form wrapped in a polyvinyl alcohol film having a thickness of less than 100 μm. The detergent composition of the invention weighs from about 8 to about 25 grams, from about 10 to about 20 grams. This weight range fits comfortably in a dishwasher dispenser. Even though this range amounts to a low amount of detergent, the detergent has been formulated in a way that provides all the benefits mentioned herein above.

Alternatively, the composition can be housed in a pack or reservoir that allows autodosing of the composition over a plurality of dishwasher operations.

The pack or reservoir containing the composition of the method of the invention can be located inside or outside of the dishwasher. If placed inside of the dishwasher, the pack or storage reservoir can be integrated into the automatic dishwasher (i.e., a storage reservoir permanently fixed (built in) to the automatic dishwasher), and can also be autarkic (i.e., an independent storage reservoir that can be inserted into the interior of the automatic dishwasher).

An example of an integrated storage reservoir is a receptacle built into the door of the automatic dishwasher and connected to the interior of the dishwasher by a supply line.

The pack can be used as a removable dosing device. The dosing device can be for example an automated unit comprising the pack and a dispensing unit capable of releasing a controlled amount of different compositions at different times, for example to the main wash and to the rinse. Different types of hardware might be part of the dosing device for controlling the dispensing of the cleaning and rinsing compositions, or for communicating with external devices such as data processing units, the dishwasher or a mobile device or server that a user can operate.

The pack has very good thermal stability, especially if it is to be located in the interior of the dishwasher.

From 1 to 25 or from 2 to 20 grams of the cleaning composition can be delivered in the main wash. It can be followed by from 1 to 15 or from 2 to 8 grams of a rinse aid composition thereafter.

Preferred processes according to the invention are those wherein the compositions, prior to being metered into the interior of the dishwasher, remains in the storage reservoir that is located outside (as for example WO2019/81910A1) or inside of the dishwasher for at least two, at least four, at least eight or at least twelve separate dishwashing programs.

The dosing system can be linked to sensors that can determine, based on sensor's input, the amount of composition required. Sensors that may be used include pH, turbidity, temperature, humidity, conductivity, etc. The dishwasher may require data processing power to achieve this. It is preferred that the dishwashing will have connectivity to other devices. This may take the form of wi-fi, mobile data, blue tooth, etc. This may allow the dishwasher to be monitored and/or controlled remotely. Preferably, this also allows the machine to connect with the internet.

The volume of preferred storage reservoirs containing one or more chambers is from 10 to 1000 ml, from 20 to 800 ml, or from 50 to 500 ml. The method of the invention comprises the following steps:
a) placing the dishware in the dishwasher;
b) delivering the cleaning composition into the cleaning cycle to form a wash liquor and subjecting the dishware to the wash liquor

The method of the invention can comprise an additional step involving the addition of rinse aid to the rinsing cycle.

### EXAMPLES

### Example 1

Automatic dishwashing compositions were made as detailed herein below.

### I. Preparation of Test Compositions

Compositions A (comparative) and B (according to the invention) were used to evaluate grit on items washed in a dishwasher as detailed herein below. Composition A is 13.34 grams of an automatic dishwashing detergent comprising 5.5 grams (active) of the tri-sodium salt of methyl glycine diacetic acid. Composition B is the same as composition A and also contains 0.2 grams of active polyVinylAcetate (PVAc) grafted PolyEthyleneOxide (PEO) with 40% PEO, 60% PVAc and Mw 27100.

### II. Test Items

| | | | Number of Replicates |
|---|---|---|---|
| | | | added and |
| Test Item | Supplier | Description | position in machine |
| Dallas Glass | Muller | Article number | 2 |
| | NV | 802002 | top rack, |
| | | | opposite corners |
| Polypropylene | Colruyt | Amuse basic | 1 |
| polystyrene | | meat box | top rack |
| rectangular | | | |
| container | | | |
| Polypropylene | Carrefour | Coolness box | 1 |
| round container | | 0.5 L | top rack |
| Polypropylene | Variapack | Prestipack | 2 |
| standard | | Combi BCS900 | 1x top rack, |
| container | | | 1x bottom rack |
| Plastic SAN | US | Article number | 2 |
| tumbler | Acrylic | 9273 | top rack, |
| | | | opposite corners |
| Black ceramic | La table | Article number | 2 |
| plate | d'arc | 0883314080193 | bottom rack, back |
| Knife | Alto | Couteau table | 2 |
| | Autlet | ingres ET1700-5 | cutlery tray |
| | NV | | |

### III. Additional Ballast Soil I

To add extra soil stress to the test, a blend of soils is added to the dishwasher, as prepared by the procedure described below:

| Ingredient | % content |
|---|---|
| Vegetable oil | 31.6 |
| Margarine | 6.3 |
| Lard | 6.3 |
| Deep-frying fat | 6.3 |
| Whole egg | 15.8 |
| Cream | 9.4 |
| Whole Milk | 6.3 |
| Potato Starch | 2.2 |
| Gravy | 1.7 |
| Wheat Flour | 0.6 |
| Quark Powder | 0.6 |
| Benzoic Acid >99% | 0.3 |
| Tomato Ketchup | 6.3 |
| Mustard | 6.3 |
| Total | 100 |

### Soil Preparation

1. Combine the vegetable oil and whole egg and mix thoroughly (approximately 30 minutes).
2. Add ketchup and mustard, still stirring vigorously.
3. Melt the fats, allow to cool to approximately 40° C., then add to the mixture and blend well.
4. Stir in the cream and milk.
5. Add the powdered solid constituents and mix everything to a smooth paste.
6. Put 50 g of the soil mix into plastic pots and freeze.

### IV. Additional Ballast Soil II

To add extra soil stress to the test, a blend of soils is added to the dishwasher, as prepared by the procedure described below:

| Ingredient | % content |
|---|---|
| Carrefour Matière grass | 49.95 |
| végétale (Cuir et Rotir) | |
| Carrefour Graisse à frire | 49.95 |
| Solvent Red 26 dye | 0.1 |

### Soil Preparation

1. Mix the Carrefour Matière grass végétale (Cuir et Rotir) and Carrefour Graisse à frire in a Thermomixer for 30 minutes at speed 2, 55° C. to melt the grease while mixing.
2. After 30 minutes add the Solvent Red 26 dye to the mixture and continue the mixing for another 15 minutes on the same settings.
3. Put 10 g of the soil mixture into plastic pots and refrigerate.

### V. Test Wash Procedure

Automatic Dishwasher: Miele, model GSL2
Wash volume: 5000 ml
Main Wash Water temperature: 45° C.
Length of the Main Wash 22 minutes (8 minutes holding)
Rinse Water temperature: 55° C.
Water hardness: 21 gpg

Main Wash Composition addition: Added into the bottom of the automatic dishwasher when the detergent dispenser opens at the start of the main wash.
Rinse Composition addition: Added into the bottom of the automatic dishwasher at the start of second (heated) rinse.
Additional soil stress: 1×50 g pot of additional ballast soil I and 1×10 g pot of additional ballast soil II added to bottom rack.

A dishwasher was loaded with the items as detailed above which were washed using Compositions A and B respectively. After running 5 consecutive cycles, the plastic tumblers were then photographed against a black background and the images were analysed using computer aided software. The image produced is analysed versus the greyscale and assigned a number to indicate the average transmission of light through the same, the blacker the image, the higher the transmission of light through the sample. Grit is defined as a circular cluster smaller than 4 pixels with higher gray scale (4 units) versus the background.

| Example | Grit Count |
|---|---|
| Composition A (comparative) | 1164 |
| Composition B (according to | 493 |
| the invention) | |

As it can be seen items washed with the composition of the invention present less grit that those washed with a composition free of the amphiphilic graft polymer of the invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A phosphate-free automatic dishwashing cleaning composition comprising:
i) from about 20% to about 50% by weight of the composition of a complexing agent selected from the group consisting of methyl glycine diacetic acid, its salts and derivatives thereof citric acid, its salts and derivatives thereof, glutamic-N,N-diacetic acid, its salts and derivatives thereof, iminodisuccinic acid, its salts and derivatives thereof, carboxy methyl inulin, its salts and derivatives thereof, aspartic acid-N,N-diacetic acid, its salts and derivatives thereof, and mixtures thereof; and
ii) an amphiphilic graft polymer based on water-soluble polyalkylene oxides as a graft base and side chains formed by polymerization of a vinyl ester component, wherein said amphiphilic graft polymer is water-soluble or water-dispersible and has a weight average molar mass (Mw) of from about 3,000 to about 100,000; and optionally
iii) a dispersant polymer.

2. A composition according to claim 1 wherein the complexing agent is selected from the group consisting of a salt of methyl glycine diacetic acid, a salt of citric acid and mixtures thereof.

3. A composition according to claim 1 wherein said amphiphilic graft polymer has an average of less than or equal to about one graft site per about 50 alkylene oxide units.

4. A composition according to claim 1 wherein said composition comprises from about 0.1% to about 10% by weight of the composition of said amphiphilic graft polymer.

5. A composition according to claim 1 wherein said amphiphilic graft polymer has a polydispersity of less than or equal to about 3.

6. A composition according to claim 1 wherein said amphiphilic graft polymer comprises less than or equal to about 10% by weight of the polyvinyl ester in ungrafted form.

7. A composition according to claim 1 wherein the amphiphilic graft polymer has
(A) from about 20% to about 70% by weight of a water-soluble polyalkylene oxide as a graft base and
(B) side chains formed by free-radical polymerization of from about 30% to about 80% by weight of a vinyl ester compound composed of
(B1) from about 70% to about 100% by weight of vinyl acetate and/or vinyl propionate and
(B2) from about 0% to about 30% by weight of a further ethylenically unsaturated monomer.

8. A composition according to claim 1 wherein said amphiphilic graft polymer has
(A) from about 30% to about 60% by weight of a water-soluble polyethylene oxide as a graft base and
(B) side chains formed by free-radical polymerization of from about 40% to about 70% by weight of a vinyl ester compound composed of
(B1) from about 70% to about 100% by weight of vinyl acetate and/or vinyl propionate and
(B2) from about 0% to about 30% by weight of a further ethylenically unsaturated monomer.

9. A composition according to claim 1 comprising from about 20% to about 40% be weight of the composition of the complexing agent.

10. A composition according to claim 1 comprising from about 0.1% to about 10% be weight of the composition of the dispersant polymer.

11. A composition according to claim 1 wherein the composition has a pH greater than about 10.5 as measured in about a 1% by weight aqueous solution at about 25° C.

12. A composition according to claim 1 further comprising enzymes.

13. A composition according to claim 1 further comprising a crystal growth inhibitor.

14. A method of preventing grit formation in automatic dishwashing comprising the step of placing a load comprising greasy soils in the dishwasher and subjecting the load to a composition according to claim 1.
